(19) United States
(12) Patent Application Publication
(10) Pub. No.: US 2024/0311803 A1
(43) Pub. Date: Sep. 19, 2024

(54) NON-FUNGIBLE TOKEN DIGITAL WALLET AS A GATEWAYFOR CONDUCTING RESOURCE-RELATED EVENTS/TRANSACTIONS

(71) Applicant: BANK OF AMERICA CORPORATION, Charlotte, NC (US)

(72) Inventors: Ravi Joshi, Pennington, NJ (US); Shweta Ambulkar, Plainsboro, NJ (US); Anna Kristen Pingel Berry, Indian Land, SC (US); Benjamin Daniel Hardman, Harrisburg, NC (US); Angela Ianni, Lincoln, RI (US); Olga Kocharyan, Matthews, NC (US); Luqman Sharief, Libertyville, IL (US); Michael Wm. Whitaker, Fort Worth, TX (US)

(73) Assignee: BANK OF AMERICA CORPORATION, Charlotte, NC (US)

(21) Appl. No.: 18/123,169

(22) Filed: Mar. 17, 2023

(51) Int. Cl. G06Q 20/36

(52) U.S. Cl. CPC G06Q 20/3674; G06Q 2220/00

(57) ABSTRACT

Generation of an NFT digital wallet that stores an NFT that serves as verified identity for the user. Both a private side/portion of the wallet having a private address and public side/portion of the wallet having a public address are generated. Additionally, a set of rules are configured that provide gateway functionality for receiving resource-related events using the private address. The public address is used for transmitting outgoing resource-related events and receiving incoming resource-related events, while the private address is used to validate at least some of the incoming resource-related events. The incoming resource-related events requiring validation is defined by the set of rules. In use, launching of the NFT digital wallet and user authentication via NFT presentation prompts presentation of the private side and outstanding incoming resource-related events awaiting validation. Once incoming resource-related events are validated and the user is re-authenticated, the public side is presented along with validated incoming resource-related events.

### FIELD OF THE INVENTION

The present invention is related to Non-Fungible Tokens (NFTs) and, more specifically, implementing an NFT digital wallet and associated NFT as gateway for conducting resource-related events.

### BACKGROUND

A Non-Fungible Token (NFT) is a unique digital identifier that is immutable (i.e., unable to be changed, copied, or subdivided over time). Such immutability is made possible by recording/storing the NFT on a distributed trust computing network, commonly referred to as blockchain network, which is used to certify the authenticity and ownership of the NFT. The “non-fungible” aspect refers to the token referencing uniquely identifiable securities, such as a digital file, include image/photo contents, audio content, video content and/or multimedia content.

An NFT digital wallet provides the means by which a user can securely access the uniquely identifiable security associated with the NFT. An NFT digital wallet provides a secure environment that allows the user to maintain private keys used for authorizing NFT transactions or the like. The private key is uniquely associated with the NFT digital wallet address.

NFT digital wallets are typically configured such that incoming resource-related events/transactions such as receipt of digital resources or the like are automatically received by wallet and processed by the associated distributed trust computing network. However, in instances in which the digital resources are being sent to the NFT digital wallet by an unknown entity, the user may have a desire to initially accept or reject the incoming resource-related event to protect against erroneous and, in certain instances ill-intentioned, resource-related events/transactions.

Therefore, a need exists to develop systems, methods and the like that would provide for a means by which an NFT digital wallet can act as a gateway for incoming resource-related events, such that user can accept or reject any and all incoming resource-related events. As a result, the desired systems, methods, and the like would guard against automated acceptance and distributed trust network processing of resource-related events deemed to be made in error or otherwise adverse the user's best interest.

### BRIEF SUMMARY

The following presents a simplified summary of one or more embodiments of the invention in order to provide a basic understanding of such embodiments. This summary is not an extensive overview of all contemplated embodiments and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing a unique means for generating/configuring an NFT digital wallet that stores an NFT that serves as verified identity for the user. Additionally, the present invention provides for subsequent use of the gateway functionality of the NFT digital wallet for purposes of safeguarding against undesirable receipt of incoming resource-related events.

Specifically, generation of the NFT digital wallet provides for generating both a private side/portion of the wallet having a private address and public side/portion of the wallet having a public address. Additionally, generation of the NFT digital wallet includes configuring a set of rules that provide gateway functionality for receiving resource-related events using the public and private addresses. In this regard, the public address is used for transmitting outgoing resource-related events and receiving incoming resource-related events. The private address is used to validate (i.e., accept) at least a portion of the incoming resource-related events. The incoming resource-related events requiring validation may be defined by the set of rules, such that all of the incoming resource-related events may require private address validation or only those incoming resource-related events received from unknown entities may require private address validation (i.e., incoming resource-related events received from known entities are automatically received and processing initiated on a corresponding distributed trust computing network).

In use, the NFT digital wallet is launched and the user is authenticated using the identity-based NFT. User authentication results in presentation of the private side/portion of the wallet and display of the incoming resource-related events requiring validation. In response to the user selecting one or more of the incoming resource-related events displayed in the private side/portion of the wallet, the private address is used to validate the selected one or more incoming resource-related events. In response to validating the selected one or more incoming resource-related events and re-authenticating the user, presentation of the public side/portion of the wallet occurs and display of the validated incoming resource-related events and, optionally, other incoming resource-related events that did not require validation.

Further embodiments of the invention provide for monitoring for occurrence of public exposure of the public address and, in response to determining occurrence of public exposure, direct the NFT via the distributed trust computing network to automatically replace the public address with a new public address while maintaining the private address. Other related embodiments of the invention provide for monitoring for occurrence of public events using or otherwise implicating the public address and, in response to the monitoring, predict (via machine learning techniques or the like) that the public events will lead to or will likely lead to an occurrence of public exposure of the public address. In response to predicting that the public events will or will likely lead to public exposure, the NFT directs via the distributed trust computing network automatic replacement of the public address with a new public address while maintaining the private address.

A system for generating a Non-Fungible Token (NFT) digital wallet that provides gateway functionality for receiving resource-related events, defines first embodiments of the invention. The system includes a first computing platform having a first memory and one or more first processing devices in communication with the first memory. The first memory stores an NFT digital wallet generator that is executable by at least one of the one or more first processing devices. The NFT digital wallet generator is configured to authenticate at least one of one or more users using an associated NFT that serves as verified identity for the one or more users. In response to authenticating the at least one of the one or more users, the NFT digital wallet generator is further configured to generate a private side of a NFT digital wallet having a private address associated with the NFT. In response to generating the private side and based on authentication of the one or more users, the NFT digital wallet generator is further configured to receive a first input from a user from amongst the one or more users, the first input configured to generate a public side of the NFT digital wallet having a public address. The NFT digital wallet generator is further configured to receive second inputs from the user that define a set of rules for the NFT digital wallet to provide gateway functionality for receiving resource-related events using the public address and private address.

In specific embodiments of the system, which are further directed to using the NFT digital wallet, the NFT digital wallet is configured to transmit outgoing resource-related events via the public address, receive incoming resource-related events via the public address, and validate at least a portion of the received incoming resource events using the private address. In related embodiments of the system, the NFT digital wallet is further configured to apply the set of rules to each of the incoming resource-related events to determine which of the incoming resource-related events require validation using the private address and which of the incoming resource-related events can be accepted without requiring validation using the private address.

In further related specific embodiments of the system, the NFT digital wallet is further configured to, in response to a user from amongst the one or more users launching the NFT digital wallet and initially authenticating the user using the NFT, present the private side of the NFT digital wallet and display information related to the incoming resource-related events requiring validation. In addition, the NFT digital wallet is further configured to receive one or more third user inputs that select for validation one or more of the incoming resource-related events requiring validation, and, in response to receiving the one or more third user inputs, use the private address to validate the selected one or more incoming resource-related events requiring validation. In further related embodiments of the system, the NFT digital wallet is further configured to, in response to validating the selected one or more incoming resource-related events requiring validation, re-authenticate the user using the NFT, and, in response to re-authenticating the user, present the public side of the NFT digital wallet and display the validated one or more incoming resource-related events requiring validation as accepted incoming resource-related events.

In other specific embodiments the system includes a second computing platform having a second memory and one or more second processing devices in communication with the second memory. The second memory stores a public address monitoring engine that is executable by at least one of the one or more second processing devices. The public address monitoring engine is configured to monitor for occurrence of public exposure of the public address, and, in response to the monitoring determining an occurrence of public exposure of the public address, direct the NFT to replace the public address with a new public address without having to replace the private address. In other specific embodiments of the system, the second memory of the second computing platform stores a public address exposure prediction engine that is executable by at least one of the one or more second processing devices. The public address exposure prediction engine is configured to monitor for occurrence of public events implementing the public address, and, in response to the monitoring determining an occurrence of one or more public events implementing the public address, implement machine learning models to predict that the one or more public events will lead to an occurrence of public exposure of the public address. In response to predicting that the one or more public events will lead to the occurrence of public exposure of the public address, the public address exposure prediction engine is further configured to direct the NFT to automatically replace the public address with a new public address without having to replace the private address.

A computer-implemented method for generating a Non-Fungible Token (NFT) digital wallet that provides gateway functionality for receiving resource-related events defines second embodiments of the invention. The method is executed by one or more computing processor device. The method includes authenticating at least one of one or more users using an NFT that serves as verified identity for the one or more users. In response to authenticating the at least one of the one or more users, the method includes generating a private side of a NFT digital wallet having a private address. In response to generating the private side and based on authentication of the at least one of the one or more users, the method further includes receiving a first input from a user from amongst the one or more users, the first input configured to generate a public side of the NFT digital wallet having a public address, and receiving second inputs from the user that define a set of rules for the NFT digital wallet to provide gateway functionality for receiving resource-related events using the public address and private address.

In specific embodiments of the method, which further provide for using the NFT digital wallet, the method includes transmitting outgoing resource-related events via the public address, receiving incoming resource-related events via the public address, and validating at least a portion of the received incoming resource events using the private address. In related specific embodiments the method further includes applying the set of rules to each of the incoming resource-related events to determine which of the incoming resource-related events require validation using the private address and which of the incoming resource-related events can be accepted without requiring validation using the private address.

In further specific embodiments the method includes, in response to a user from amongst the one or more users launching the NFT digital wallet and initially authenticating the user using the NFT, presenting the private side of the NFT digital wallet and displaying information related to the incoming resource-related events requiring validation. In addition, the method includes receiving one or more third user inputs that select for validation one or more of the incoming resource-related events requiring validation, and, in response to receiving the one or more third user inputs, the method includes using the private address to validate the selected one or more incoming resource-related events requiring validation. In related specific embodiments the method includes, in response to validating the selected one or more incoming resource-related events requiring validation, re-authenticating the user using the NFT. In response to re-authenticating the user, the method includes presenting the public side of the NFT digital wallet and displaying the validated one or more incoming resource-related events requiring validation as accepted incoming resource-related events.

In additional specific embodiments the method includes monitoring for occurrence of public exposure of the public address; and, in response to the monitoring determining an occurrence of public exposure of the public address, directing the NFT to automatically replace the public address with a new public address without having to replace the private address. In other specific embodiments the method includes monitoring for occurrence of public events implementing the public address and, in response to the monitoring determining an occurrence of one or more public events implementing the public address, implementing machine learning models to predict that the one or more public events will lead to an occurrence of public exposure of the public address. In response to predicting that the one or more public events will lead to the occurrence of public exposure of the public address, the method includes directing the NFT to automatically replace the public address with a new public address without having to replace the private address.

A computer program product including a non-transitory computer-readable medium defines third embodiments of the invention. The compute-readable medium includes sets of codes for causing one or more computing processing devices to authenticate at least one of one or more users using an NFT that serves as verified identity for the one or more users. In response to authenticating the at least one of the one or more users, the sets of codes cause the computing processing device(s) to generate a private side of a NFT digital wallet having a private address. In response to generating the private side and based on authentication of the at least one of the one or more users, the sets of codes cause the computing processing device(s) to receive a first input from a user from amongst the one or more users, the first input configured to generate a public side of the NFT digital wallet having a public address, and receive second inputs from the user that define a set of rules for the NFT digital wallet to provide gateway functionality for receiving resource-related events using the public address and private address.

In specific embodiments of the computer program product, the sets of codes further cause the one or more computing processing devices to transmit outgoing resource-related events via the public address, receive incoming resource-related events via the public address, and validate at least a portion of the received incoming resource events using the private address. In related specific embodiments of the computer program product, the sets of codes further cause the one or more computing processing devices to apply the set of rules to each of the incoming resource-related events to determine which of the incoming resource-related events require validation using the private address and which of the incoming resource-related events can be accepted without requiring validation using the private address.

In other specific embodiments of the computer program, the sets of codes further cause the one or more computing processing devices to, in response to a user from amongst the one or more users launching the NFT digital wallet and initially authenticating the user using the NFT, present the private side of the NFT digital wallet and displaying information related to the incoming resource-related events requiring validation. In addition, the sets of codes further cause the one or more computing processing devices to receive one or more third user inputs that select for validation one or more of the incoming resource-related events requiring validation; and, in response to receiving the one or more third user inputs, use the private address to validate the selected one or more incoming resource-related events requiring validation.

In further specific embodiments of the computer program product, the sets of codes further cause the one or more computing processing devices to monitor for occurrence of public exposure of the public address, and, in response to the monitoring determining an occurrence of public exposure of the public address, direct the NFT to automatically replace the public address with a new public address without having to replace the private address. In related specific embodiments of the computer program product, the sets of codes further cause the one or more computing processing devices to monitor for occurrence of public events implementing the public address and, in response to the monitoring determining an occurrence of one or more public events implementing the public address, implement machine learning models to predict that the one or more public events will lead to an occurrence of public exposure of the public address. In response to predicting that the one or more public events will lead to the occurrence of public exposure of the public address, the sets of codes further cause the one or more computing processing devices to direct the NFT to automatically replace the public address with a new public address without having to replace the private address.

Thus, according to embodiments of the invention, which will be discussed in greater detail below, the present invention provides for generating an NFT digital wallet that stores an NFT that serves as verified identity for the user. The NFT digital wallet is generated with both a private side/portion of the wallet having a private address and public side/portion of the wallet having a public address are generated. Additionally, a set of rules are configured that provide gateway functionality for receiving resource-related events using the private address. The public address is used for transmitting outgoing resource-related events and receiving incoming resource-related events, while the private address is used to validate at least some of the incoming resource-related events. The incoming resource-related events requiring validation is defined by the set of rules. In use, launching of the NFT digital wallet and user authentication via NFT presentation prompts presentation of the private side and outstanding incoming resource-related events awaiting validation. Once incoming resource-related events are validated and the user is re-authenticated, the public side is presented along with validated incoming resource-related events. In addition, alternate embodiments of the invention provide for automatically updating/replacing the public address in response to an occurrence of a public exposure event or predicting the likely occurrence of a public exposure event. Such updating/replacement of the public address occurs without having to update/replace the private address.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the disclosure in general terms, reference will now be made to the accompanying drawings, wherein:

FIG. 1 is a schematic/block diagram of a system for generating a Non-Fungible Token (NFT) digital wallet that provides gateway functionality for transmitting and receiving resource-related events, in accordance with embodiments of the present invention;

FIG. 2 is schematic/block diagram of a system for generating a Non-Fungible Token (NFT) digital wallet that provides gateway functionality for transmitting and receiving resource-related events including monitoring of public exposure of the public address and automatically updating the public address in response to public exposure, in accordance with embodiments of the present invention;

FIG. 3 is schematic/block diagram of a system for generating a Non-Fungible Token (NFT) digital wallet that provides gateway functionality for transmitting and receiving resource-related events including monitoring for public events implementing the public address, predicting the likelihood of public exposure based on the public events and automatically updating the public address in response to the predicted likelihood of public exposure, in accordance with embodiments of the present invention;

FIG. 4 is a flow diagram of a method for generating a Non-Fungible Token (NFT) digital wallet that provides gateway functionality for transmitting and receiving resource-related events, in accordance with embodiments of the present;

FIG. 5 is a flow diagram of a method for using a Non-Fungible Token (NFT) digital wallet that provides gateway functionality for transmitting and receiving resource-related events, in accordance with embodiments of the present;

FIG. 6 is a flow diagram of a method for monitoring of public exposure of the public address and automatically updating the public address in response to public exposure, in accordance with embodiments of the present invention;

FIG. 7 is a flow diagram of a method for monitoring for public events implementing the public address, predicting the likelihood of public exposure based on the public events and automatically updating the public address in response to the predicted likelihood of public exposure, in accordance with embodiments of the present invention;

FIG. 8 is a schematic diagram of a distributed trust computing network, in accordance with embodiments of the present invention;

FIG. 9 is a block diagram of an event object stored within a distributed ledger of a distributed trust computing network, in accordance with some embodiments of the present disclosure;

FIG. 10 is a schematic diagram of system for generating a Non-Fungible Token (NFT) and storing the NFT within a distributed trust computing network, in accordance with embodiments of the present invention; and

FIG. 11 is a block diagram of an architecture for an exemplary NFT; in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be appreciated by one of skill in the art in view of this disclosure, the present invention may be embodied as a system, a method, a computer program product, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer-readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted, or unscripted programming language such as JAVA, PERL, SMALLTALK, C++, PYTHON, or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or systems. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus to cause a series of operational events to be performed on the computer or other programmable apparatus to produce a computer implemented process such that the instructions, which execute on the computer or other programmable apparatus, provide events for implementing the functions/acts specified in the flowchart and/or block diagram block or blocks. Alternatively, computer program implemented events or acts may be combined with operator or human implemented events or acts in order to carry out an embodiment of the invention.

As the phrase is used herein, a processor may be “configured to” perform or “configured for” performing a certain function in a variety of ways, including, for example, by having one or more general-purpose circuits perform the function by executing particular computer-executable program code embodied in computer-readable medium, and/or by having one or more application-specific circuits perform the function.

Thus, according to embodiments of the invention, which will be described in more detail below, systems, methods and computer program products are disclosed that providing a unique means for generating/configuring an NFT digital wallet that stores an NFT that serves as verified identity for the user. Specifically, the present invention provides for a gateway functionality within the NFT digital wallet for purposes of safeguarding against undesirable receipt of incoming resource-related events.

In specific embodiments of the invention, the NFT digital wallet is generated with both a private side/portion having a private address and public side/portion having a public address. Additionally, the NFT digital wallet is configured to include a set of rules that provide gateway functionality for receiving resource-related events using the private address. In this regard, the public address is used for transmitting outgoing resource-related events and receiving incoming resource-related events, while the private address is used to validate (i.e., accept) at least a portion of the incoming resource-related events. The incoming resource-related events requiring validation may be defined by the set of rules, such that all of the incoming resource-related events may require private address validation or only those incoming resource-related events received from unknown entities may require private address validation (i.e., incoming resource-related events received from known entities are automatically received and processing initiated on a corresponding distributed trust computing network).

In further specific embodiments of the invention, which are directed to use of the NFT digital wallet, the wallet is launched and the user is authenticated using the identity-based NFT. In response to successful user authentication, the private side/portion of the wallet is presented and the incoming resource-related events requiring validation are presented. In response to the user selecting one or more of the incoming resource-related events displayed in the private side/portion of the wallet, the private address is used to validate the selected one or more incoming resource-related events. In response to validating the selected one or more incoming resource-related events and re-authenticating the user, the public side/portion of the wallet is presented and the validated incoming resource-related events are displayed along with any other incoming resource-related events not requiring validation.

Further embodiments of the invention provide for monitoring for occurrence of public exposure of the public address and, in response to determining occurrence of public exposure, the NFT directs, via the distributed trust computing network, automatic replacement of the public address with a new public address while maintaining the existing private address. Other related embodiments of the invention provide for monitoring for occurrence of public events using or otherwise implicating the public address and, in response to the monitoring/tracking the public events, implementing machine learning techniques or the like to predict that the public events will likely lead to or will lead to an occurrence of public exposure of the public address. In response to predicting that the public events will or will likely lead to public exposure, the NFT directs via the distributed trust computing network automatic replacement of the public address with a new public address while maintaining the private address.

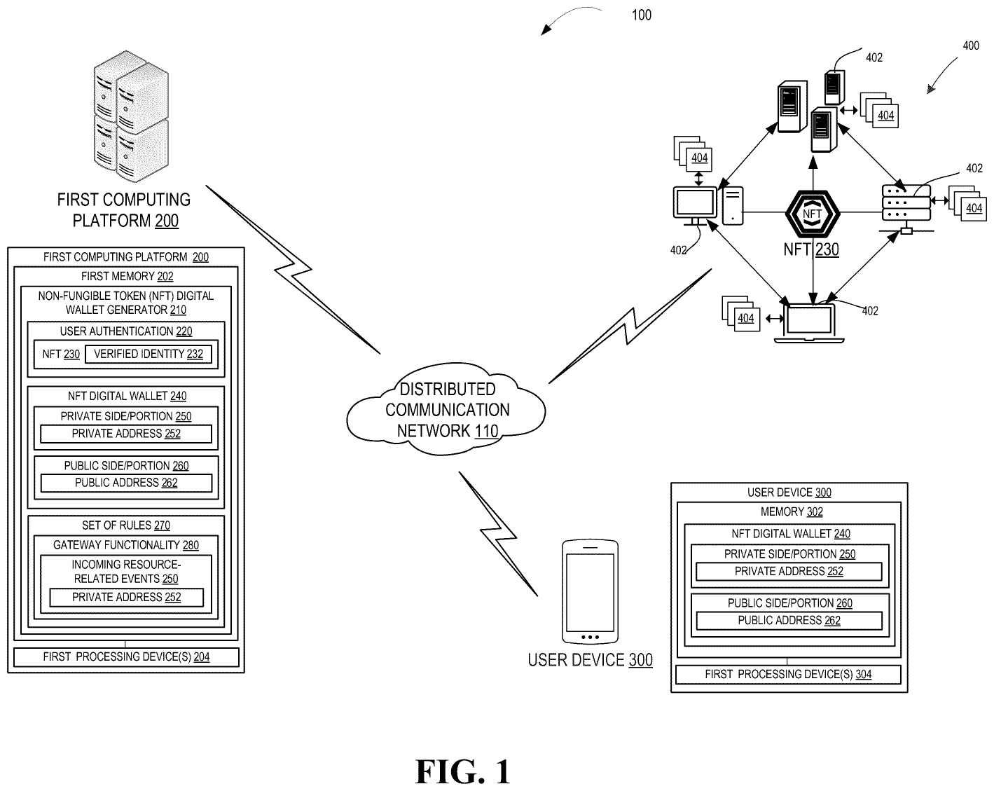

Referring to FIG. 1, a schematic/block diagram is provided of a system 100 for generating a Non-Fungible Token (NFT) digital wallet that provides gateway functionality for transmitting and receiving resource-related events, in accordance with embodiments of the present invention. The system 100 is executable throughout distributed communications network 110, which may comprise the Internet, one or more intranets, one or more cellular communication networks or the like. The system 100 includes a first computing platform 200 having a first memory 202 and one or more first processing devices 204 in communication with the first memory 202. First memory 202 stores NFT digital wallet generator 210 that is configured to generate a Non-Fungible Token (NFT) digital wallet 240 that provides gateway functionality for transmitting and receiving resource-related events.

Initially, NFT digital wallet generator 210 is configured to perform user authentication 220 to authenticate an individual user or a user from amongst a group of users (e.g., business entity, family, or the like). User authentication 220 is performed by presentation of an authentication NFT 230 that serves as verified identity 231 for the user or group of users. The authentication NFT may be generated/minted using digital resources (e.g., image, video, audio file(s) or the like) and user identification credentials (e.g., personal data, passcodes, and the like). In specific embodiments of the invention, the digital resources and user identification credentials are one and the same (e.g., image or video of the user(s) or the like). The digital resources and user identification credentials provide the inputs to the cryptographic hash algorithms used to generate/mint the authentication NFT 230.

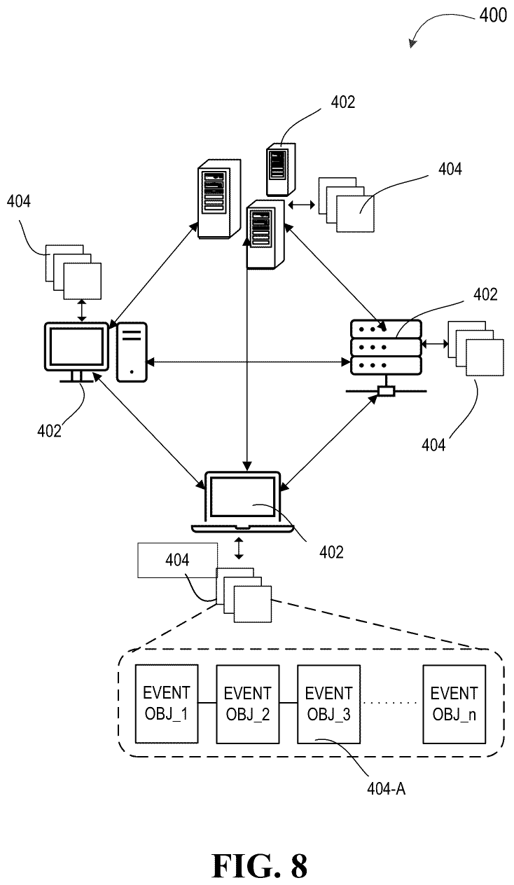

Further, authentication NFT 230 may be stored in or accessible via the NFT digital wallet 240 being generated by NFT digital wallet generator 210. Storage of the NFT 230 within the distributed ledger 404 of various nodes 402 of distributed trust computing network 230 is considered to be “on-chain” storage. Further details concerning a distributed trust computing network 400 are discussed in relation to FIG. 8, infra. While storage external from the distributed trust computing network 240, such as within NFT digital wallet 240 is considered to be “off-chain” storage (i.e., distinct from the distributed trust computing network 400).

In response to successful user authentication 220, NFT digital wallet generator 210 is configured to generate a private side/portion 250 of the NFT digital wallet having a private address 252, otherwise referred to as a public “key”. Private address 252 is configured for use by the user(s) in validating/accepting at least a portion of the incoming resource-related events 290, otherwise referred to as resource-related “transactions”.

In response to generating the private side/portion 250 and user authentication 220 (i.e., either the initial user authentication or a re-authentication conducted after generating the private side/portion 250), NFT digital wallet generator 210 is configured to receive inputs from the user and based on the inputs, generate a public side/portion 260 of the NFT digital wallet 240. Public side/portion 260 has a public address 262. Public address 262 serves to identify the NFT digital wallet 240 to external entities/users. In this regard, public address 262 is configured for transmitting outgoing resource-related events to external entities/users and receiving incoming resource-related events from external entities/user.

Further, NFT digital wallet generator 210 is configured to receive user inputs that define a set of rules 270 for the NFT digital wallet 240 to provide gateway functionality 280 for receiving/processing incoming resource-related events 290. In this regard, set of rules 270 may define which external entities/users are exempt from having their incoming resource-related events 290 undergo private address/key 252 validation/acceptance (i.e., which incoming resource-related events 290 can automatically be accepted without having to have the user apply the private address/key 252 for purposes of validation/acceptance). In this regard, set of rules 270 may define which known external entities/users, such as friends, family members, or entities which the user has conducted resource-related events in the past for validation/acceptance exclusion.

By way of example only, once NFT digital wallet 240 is generated, the NFT digital wallet 240 is stored within memory 302 of user device 300 and executable by one or more of the processing devices 304 that are in communication memory 302.

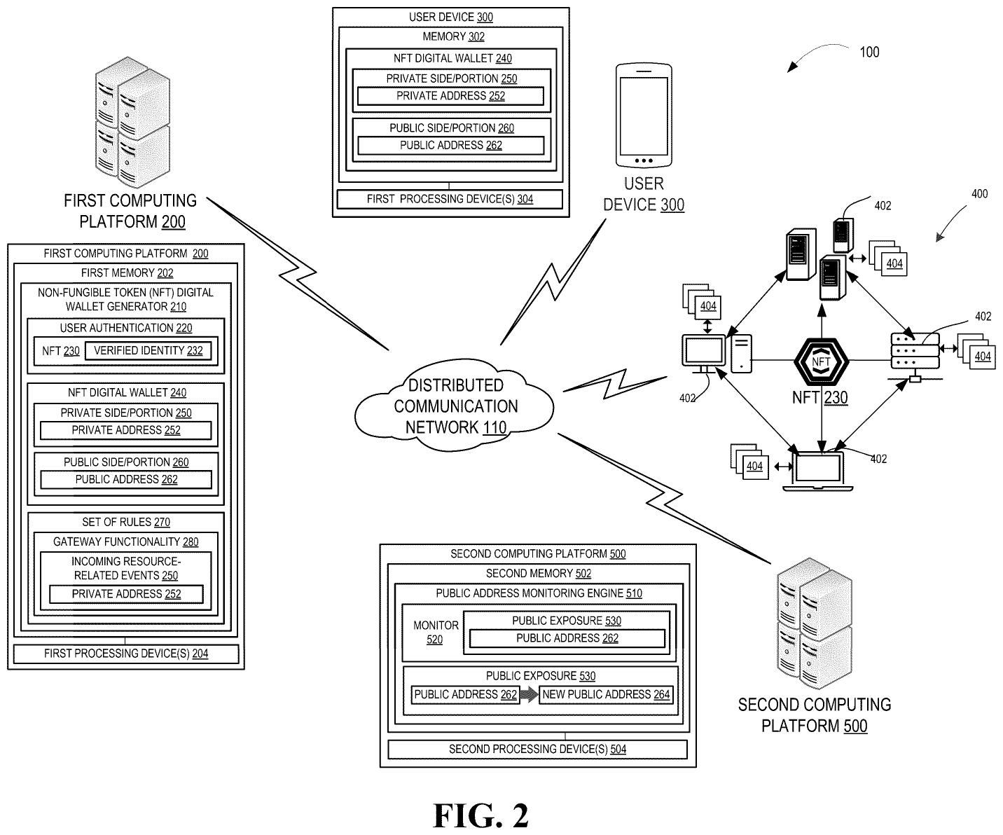

Referring to FIG. 2, a schematic/block diagram is provided of system 100-A for generating a Non-Fungible Token (NFT) digital wallet that provides gateway functionality for transmitting and receiving resource-related events including monitoring of public exposure of the public address and automatically updating the public address in response to public exposure, in accordance with embodiments of the present invention. Similar to system 100 shown in FIG. 1, system 100-A includes a first computing platform 200 having a first memory 202 and one or more first processing devices 204 in communication with the first memory 202. In addition, system 100-A includes second computing platform 500 having a second memory 502 and one or more second processing devices 504 in communication with second memory 504. First/second memory 202, 502 may comprise volatile and non-volatile memory, such as read-only and/or random-access memory (RAM and ROM), EPROM, EEPROM, flash cards, or any memory common to computing platforms). Moreover, first/second memory 202, 502 may comprise cloud storage, such as provided by a cloud storage service and/or a cloud connection service.

First/Second processing devices 204, 504 may be application-specific integrated circuits (“ASIC”), or other chipset, logic circuit, or other data processing device(s). First/second processing device(s) 204, 504 may execute one or more application programming interface (APIs) (not shown in FIGS. 1-3) that interface with any resident programs, such as NFT digital wallet generator 210 or the like, stored in first memory 202 of first computing platform 200 and/or public address monitoring engine 510, stored in second memory 502 of second computing platform 500 and any external programs. First/second processing devices(s) 204, 504 may include various processing subsystems (not shown in FIGS. 1-3) embodied in hardware, firmware, software, and combinations thereof, that enable the functionality of first computing platform 200 and second computing platform 500 and the operability of first computing platform 200 and second computing platform 500 on a distributed communication network 110, such as the Intranet, cellular network(s) and the like. For example, processing subsystems allow for initiating and maintaining communications and exchanging data with other networked devices. For the disclosed aspects, processing subsystems of first computing platform 200 and/or second computing platform 500 may include any subsystem used in conjunction with authentication NFT digital wallet generator 210, public address monitoring engine 510 and related tools, routines, sub-routines, algorithms, sub-algorithms, sub-modules thereof.

In specific embodiments of the system 100-A, first computing platform 200 and/or second computing platform 500 may additionally include a communications module (not shown in FIGS. 1-3) embodied in hardware, firmware, software, and combinations thereof, that enables electronic communications between the first computing platform 200/second computing platform 500 and other networks and network devices, such as user device 300, distributed trust computing network 400 and the like. Thus, communication module may include the requisite hardware, firmware, software and/or combinations thereof for establishing and maintaining a network communication connection with one or more devices and/or networks.

As previously discussed in relation to FIG. 1, first memory 202 of first computing platform 200 stores NFT digital wallet generator 210, which is executable by one or more of the first processing devices 204. NFT digital wallet generator 210 is the same as that which is shown in FIG. 1 and described at length previously. As such, for the sake of brevity, NFT digital wallet generator 210, as it pertains to system 100-A, will not be described at length during the discussion of FIG. 2.

System 100-A additionally includes second computing platform 500 having a second memory 502 and one or more second processing devices 504 in communication with the second memory 502. In specific embodiments of the invention, second computing platform 500 is embodied in one or more of the nodes 402 of the distributed trust computing network 400. Second memory 502 stores public address monitoring engine 510 that is executable by one or more of the second processing devices 504. In specific embodiments of the invention, public address monitoring engine 510 is part of or otherwise governed by a smart contract associated with NFT 230. Public address monitoring engine 510 is configured to monitor 520 various networks, including, but not necessarily limited to, the Internet for public exposure 530 (i.e., unauthorized use/exposure or the like) of the public address 262. In response to determining one or more occurrences of public exposure 530 of the public address 262, public address monitoring engine 510 is configured to direct the NFT 230 to automatically update/replace the public address 262 with a new public address 264. Such updating/replacement of the public address occurs without impacting or otherwise dictating update/replacement of the private address 252 and may occur without the knowledge of the user.

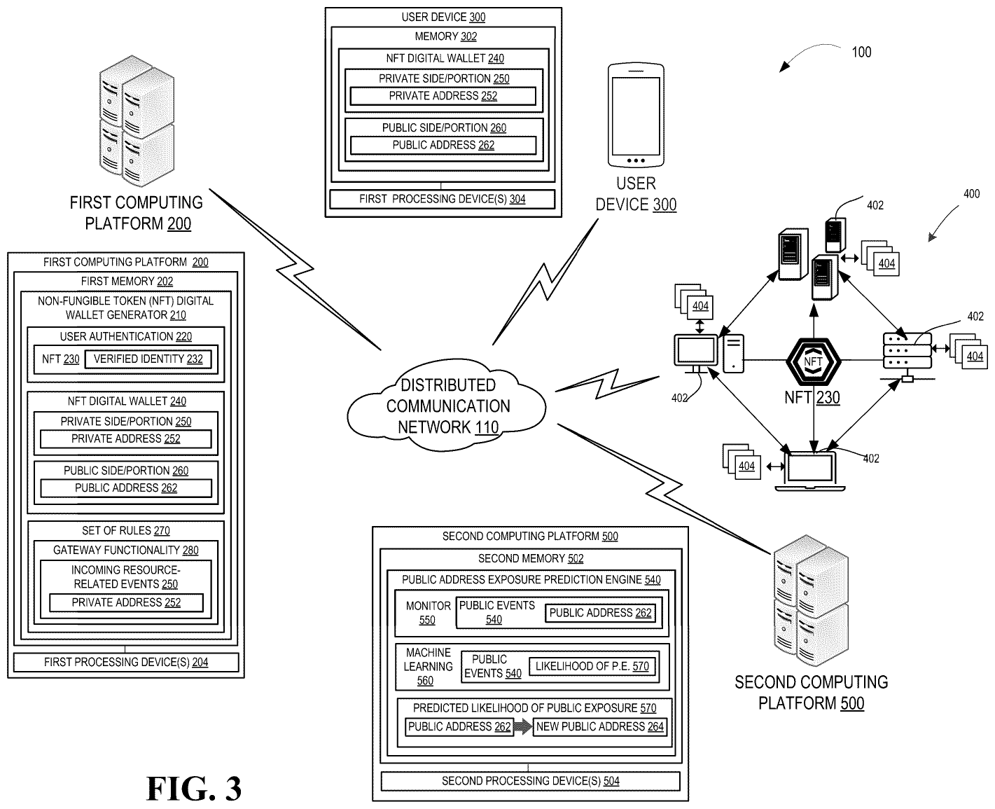

Referring to FIG. 3, a schematic/block diagram is provided of a system 100-B for generating a Non-Fungible Token (NFT) digital wallet that provides gateway functionality for transmitting and receiving resource-related events including monitoring for public events implementing the public address, predicting the likelihood of public exposure based on the public events and automatically updating the public address in response to the predicted likelihood of public exposure, in accordance with embodiments of the present invention. Similar to system 100 shown in FIG. 1, system 100-B includes a first computing platform 200 having a first memory 202 and one or more first processing devices 204 in communication with the first memory 202 and a second computing platform 300 having a second memory 302 and one or more second processing devices 304 in communication with second memory 304.

As previously discussed in relation to FIG. 1, first memory 202 of first computing platform 200 stores NFT digital wallet generator 210, which is executable by one or more of the first processing devices 204. NFT digital wallet generator 210 is the same as that which is shown in FIG. 1 and described at length previously. As such, for the sake of brevity, NFT digital wallet generator 210, as it pertains to system 100-A, will not be described at length during the discussion of FIG. 3.

System 100-B additionally includes second computing platform 500 having a second memory 502 and one or more second processing devices 504 in communication with the second memory 502. In specific embodiments of the invention, second computing platform 500 is embodied in one or more of the nodes 402 of the distributed trust computing network 400. Second memory 502 stores public address exposure prediction engine 540 that is executable by one or more of the second processing devices 504. In specific embodiments of the invention, public address exposure prediction engine 540 is part of or otherwise governed by a smart contract associated with NFT 230. Public address exposure prediction engine 510 is configured to monitor 550 various networks, including, but not necessarily limited to, the Internet for public events 560 implementing or otherwise associated with the public address 262. Public events may include transactions that rely on the public address 262 or any other public event. In response to determining one or more occurrences of public events 560 of the public address 262, public address exposure prediction engine 540 is configured to implement machine learning models 560 to predict the likelihood of the public events 560 leading to public exposure 580. In response to the likelihood of public exposure 580 exceeding a predetermined likelihood threshold, public address exposure prediction engine 540 is configured to direct the NFT 230 to automatically update/replace the public address 262 with a new public address 264. Such updating/replacement of the public address occurs without impacting or otherwise dictating update/replacement of the private address 252 and may occur without the knowledge of the user.

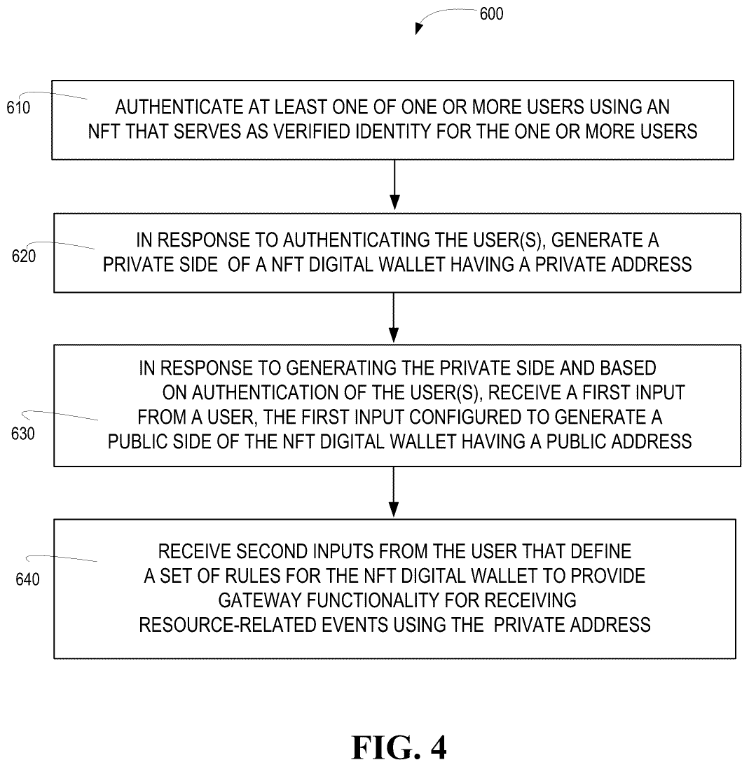

Referring to FIG. 4, a flow diagram is presented of a method 600 for generating a Non-Fungible Token (NFT) digital wallet that provides gateway functionality for transmitting and receiving resource-related events, in accordance with embodiments of the present invention. At Event 610, an individual user or a user from amongst a group of users (e.g., family member, business organization/entity or the like) is authenticated using an authentication NFT that serves as the verified identity for the user(s). In this regard, the authentication NFT is generated/minting using user credentials (e.g., personal data, passcode(s), or the like) as at least a portion of the input to the cryptographic algorithms used to generate the NFT. The authentication NFT may be stored on-chain within a distributed trust computing network or off-chain, such as within the NFT digital wallet being generated.

In response to successfully authenticating the user(s), at Event 620, a private side/portion of the NFT digital including an associated private address is generated. The private side portion of the NFT digital wallet serves as a gateway zone for incoming resource-related events/transactions that require validation (i.e., require the user to accept the incoming resource-related events through application of the private address/key).

In response to generating the private side/portion of the NFT digital wallet and based on authentication of the user(s) (either the initial authentication or a re-authentication of the user(s) prompted by generation of the private side/portion of the NFT digital wallet, at Event 630, first user inputs are received from the user that are configured to generate a public side/portion of the NFT digital wallet including an associated public address. The public side/portion of the NFT is used to transmitting outgoing resource-related events and receive incoming resource-related events that (i) do not require validation or (ii) have been validated/accepted by the user through application of the private address/key.

At Event 640, second user inputs are received from the user that define a set of rules for the digital wallet. The set of rules provide gateway functionality for receiving resource-related events using the private address. For example, the set of rules may define the addresses of users from which incoming resource-related events can be received without requiring validation/acceptance (i.e., without requiring application of the private address). Thus, incoming resource-related events that come from such addresses will bypass the private side/portion of the wallet and immediately be placed in the public side/portion of the NFT digital wallet.

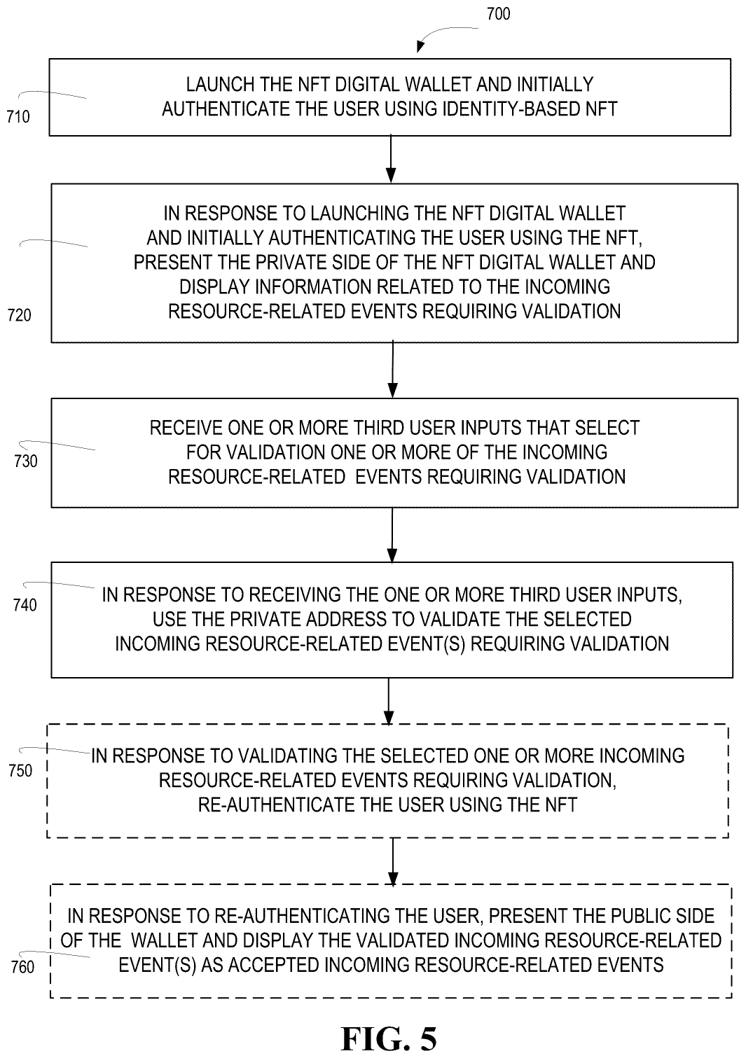

Referring to FIG. 5, a flow diagram is presented of a method 700 for implementing a Non-Fungible Token (NFT) digital wallet that provides gateway functionality for transmitting and receiving resource-related events, in accordance with embodiments of the present invention. At Event 710, the NFT digital wallet is launched and initial user authentication is performed using the identity-based NFT as the means for authentication.

In response to launching the NFT digital wallet and successfully authenticating the user using the identity-based NFT, at Event 720, the private side of the digital wallet is presented to the user and information related to the incoming resource-related events requiring validation is displayed (e.g., type of event, volume of resources, sender of resource-related event and the like). At Event 730, user inputs are received that select one or more of the incoming resource-related events requiring validation. In response to receiving the user inputs, at Event 740, the private address is applied to the selected incoming resource-related events to validate/accept the selected incoming resource-related events. By providing for the need to validate incoming resource-related events the present invention provides security against accepting and processing (via the distributed trust computing network) resource-related events that the user does not desire to accept (due to error in receipt or unknowing sender trying to implicate the recipient in an illegal or wrongful action).

In response to validating the selected incoming resource-related events, at optional Event 750, re-authentication of the user is performed using the identity-based NFT. In response to successful re-authentication of the user, at optional Event 760, the public side of the NFT digital wallet is presented and the validated incoming resource-related events are display as being accepted incoming resource-related events.

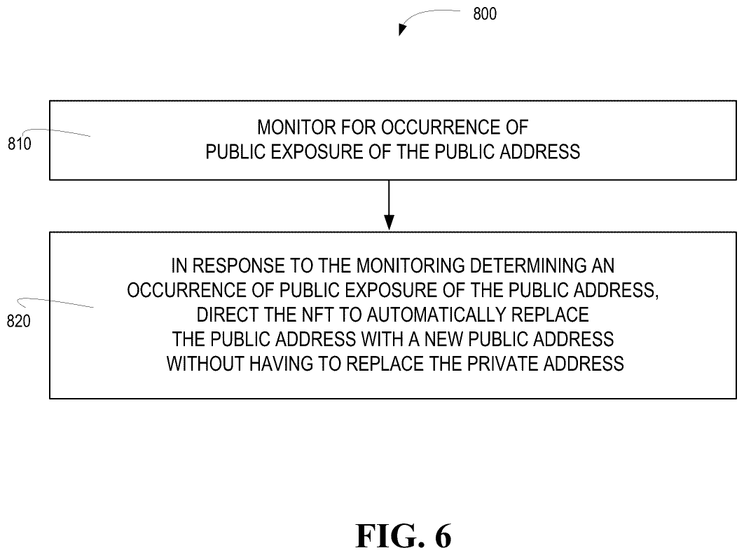

Referring to FIG. 6, a flow diagram is presented of a method 800 for monitoring of public exposure of the public address and automatically updating the public address in response to public exposure, in accordance with embodiments of the present invention. At Event 810, computing networks, such as the Internet and the like are monitored for occurrence of public exposure of the public address associated with a public side of an NFT digital wallet. Since the public address is used to transmit outgoing resource-related events to third-party recipients and to receive incoming resource-related events from third-party senders, the likelihood of public exposure of the public address is increased.

In response to the monitoring resulting in determination/detection of an occurrence of public exposure of the public address, at Event 820, the NFT is directed to automatically replace the existing public address with a new public address without having to replace the private address and without requiring any further actions on the part of the user (in this regard, the user may be unaware that the public address is undergoing replacement or may be notified after the replacement has occurred).

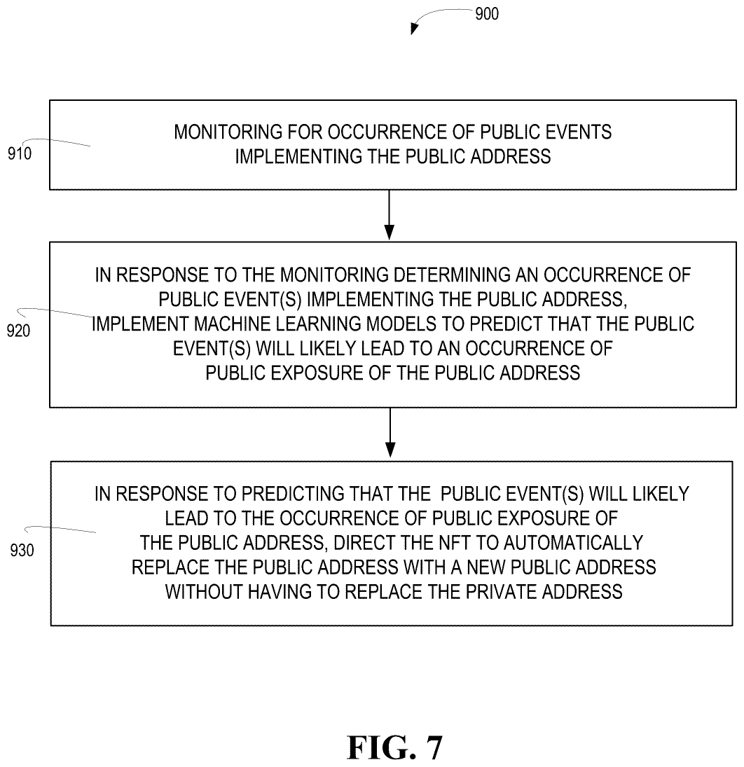

Referring to FIG. 7, a flow diagram is presented of a method 900 for monitoring for public events implementing the public address, predicting the likelihood of public exposure based on the public events and automatically updating the public address in response to the predicted likelihood of public exposure, in accordance with embodiments of the present invention. At Event 910, computing networks, such as the Internet or the like are monitored for public events associated with or otherwise implementing a public address. For example, the public event may be a data breach by an entity that a digital wallet has or may have conducted events with in the past.

In response to the monitoring resulting in determination/detection of one or more occurrences of public events associated with or implementing the public address, at Event 920, machine learning model(s) are executed to predict the likelihood that the public event will result in public exposure of the public address. In response to the predicting that the likelihood of public exposure exceeds a predetermined likelihood threshold, at Event 930, the NFT is directed to automatically replace the existing public address with a new public address without having to replace the private address and without requiring any further actions on the part of the user (in this regard, the user may be unaware that the public address is undergoing replacement or may be notified after the replacement has occurred).

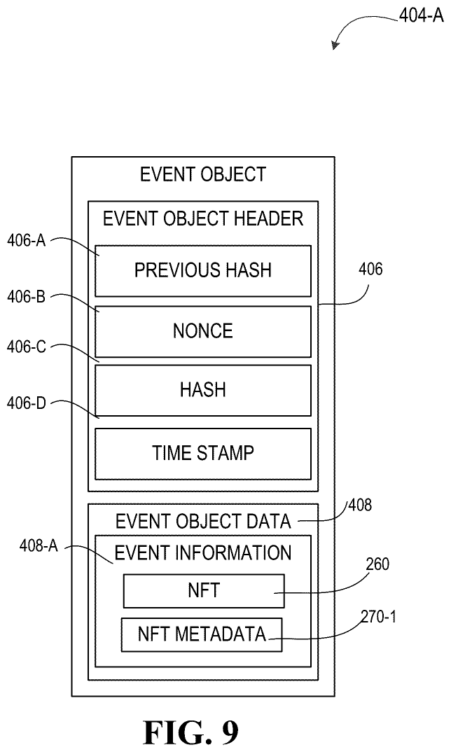

Referring to FIGS. 8 and 9, schematic/block diagram illustrate an exemplary distributed ledger technology (DLT) architecture implemented in a distributed trust computing network (commonly referred to as a “blockchain” network), in accordance with embodiments of the invention. DLT may refer to the protocols and supporting infrastructure that allow computing devices (peers) in different locations to propose and validate events and update records in a synchronized way across a network. Accordingly, DLT is based on a decentralized model, in which these peers collaborate and build trust over the network. To this end, DLT involves the use of potentially peer-to-peer protocol for a cryptographically secured distributed ledger of events represented as event objects that are linked. As event objects each include information about the event object before it, they are linked with each additional event object, reinforcing the previously ones stored prior. Therefore, distributed ledgers are resistant to modification of their data because once recorded, the data in any given event object cannot be altered retroactively without altering all subsequent event objects.

To permit events and agreements to be carried out among various peers without the need for a central authority or external enforcement mechanism, DLT uses smart contracts. Smart contracts are computer code that automatically executes all or parts of an agreement and is stored on a DLT platform. The code can either be the sole manifestation of the agreement between the parties or may complement a traditional text-based contract and execute certain provisions, such as conducting an event between Party A to Party B. The computer code of the smart contract itself is replicated across multiple nodes (peers) and, therefore, benefits from the security, permanence, and immutability that a distributed ledger offers. That replication also means that as each new event object is added to the distributed ledger, the code is, in effect, executed. If the parties have indicated, by initiating an event, that certain parameters have been met, the code will execute the step triggered by those parameters. If no such event has been initiated, the code will not take any steps.

Various other specific-purpose implementations of distributed ledgers have been developed. These include distributed domain name management, decentralized crowd-funding, synchronous/asynchronous communication, decentralized real-time ride sharing and even a general-purpose deployment of decentralized applications. A distributed ledger may be characterized as a public distributed ledger, a consortium distributed ledger, or as is the case in the present invention, a private (i.e., non-public and/or proprietary) distributed ledger. A public distributed ledger is a distributed ledger that any entity can access, communicate events to and expect to see them stored thereon if they nodes of the distributed trust computing network come to a consensus and find the events to be valid. Further, any entity can participate in the consensus process for determining which event objects are valid and, therefore, are added to the distributed ledger and determination of the current state of each event object. A public distributed ledger is generally considered to be fully decentralized. On the other hand, a fully private distributed ledger is a distributed ledger in which permissions are kept centralized with one entity (i.e., the entity that controls/owns the private distributed trust computing network and the private distributed ledgers stored thereon). The permissions may be public or restricted to an arbitrary extent. And lastly, a consortium distributed ledger is a distributed ledger where the consensus process is controlled by a pre-selected set of nodes; for example, a distributed ledger may be associated with a specified number of member institutions, each of which operate in such a way that a quorum of the members must sign every event object for the event object to be valid. The right to access such a distributed ledger may be public or restricted to the participants. Consortium distributed ledgers may be considered partially decentralized.

As shown in FIG. 8, an exemplary distributed trust computing network 400 includes a distributed ledger 404 being maintained on multiple devices (nodes) 402 that are authorized to keep track of the distributed ledger 404. For example, the nodes 402 may be one or more computing devices such as a comprehensive computing system and one or more client device(s). Each node 402 in the distributed trust computing network 400 may have a complete or partial copy of the entire distributed ledger 404 or set of events and/or event objects 404-A on the distributed ledger 404. Events are initiated at a node and communicated to the various nodes in the distributed trust computing network 400. Any of the nodes 402 can validate an event, record the event to its copy of the distributed ledger 404, and/or broadcast the event, the validation of the event (in the form of an event object) and/or other data to other nodes 402.

FIG. 9 depicts an exemplary event object 404-A. In embodiments of the present invention the event is generation of an NFT and the event object may store the NFT 240 and/or metadata 242 associated with the NFT 240. Event object 404-A includes an event header 406 and an event object data 408. The event header 406 may include a cryptographic hash of the previous event object 406-A; a nonce 406-B, i.e., a randomly generated 32-bit whole number; a cryptographic hash of the current event object 406-C wedded to the nonce 406-B; and a time stamp 406-D. The event object data 408 may include event information 408-A being recorded, such as NFT 240. Once the event object 404-A is generated, the event information 408-A is considered signed and forever tied to its nonce 406-B and hash 406-C. Once generated, the event object 404-A is then deployed on the distributed ledger 404. At this time, a distributed ledger address is generated for the event object 404-A, i.e., an indication of where the event object is located on the distributed ledger 404 and captured for recording purposes. Once deployed, the event information 408-A is considered recorded in the distributed ledger 404.

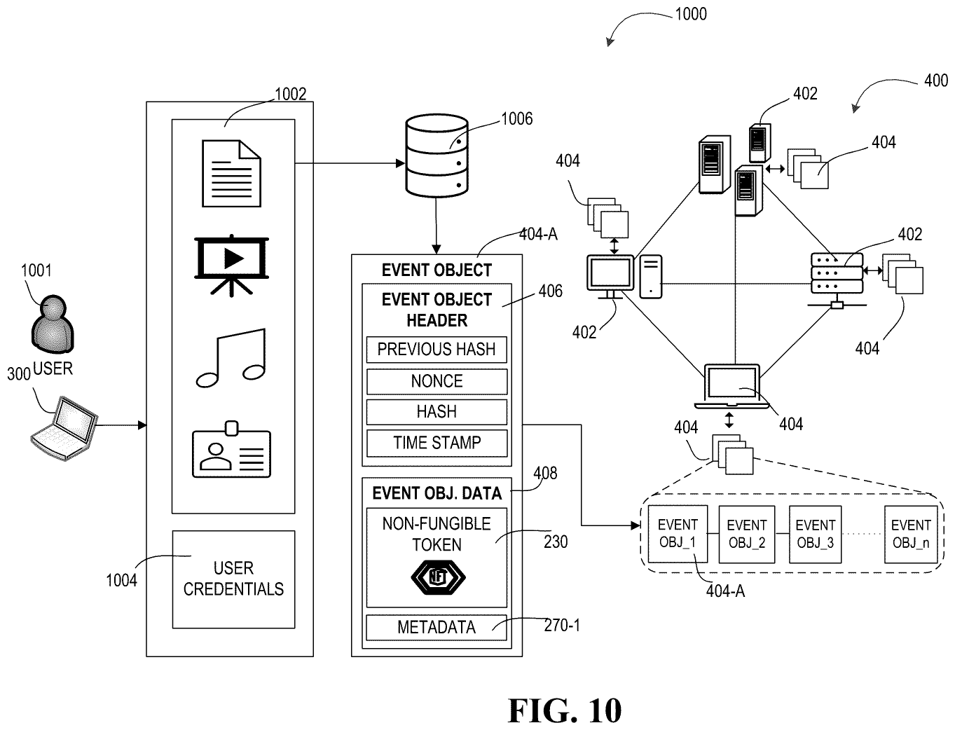

FIG. 10 illustrates an exemplary process of generating a secure token, such as a Non-Fungible Token (NFT) 230, in accordance with embodiments of the invention. One of ordinary skill in the art will readily appreciate that an NFT is a cryptographic record (referred to as a “token”) that is linked to resources, such as user credentials, digital objects or the like. Authentication NFT 230 may be stored on a distributed ledger 404 of a distributed trust computing network 400. However, according to embodiments of the invention, authentication NFT 230 may be stored external from the distributed trust computing network, such as at a network location or at a user's device. In such embodiments of the invention, in which authentication NFT 230 is stored external from the distributed trust computing network, metadata 270-1 associated with authentication NFT 230 is stored on the distributed ledger 404. The storage of the NFT 230 on the distributed ledger 404 or the storage of the metadata 270-1 means that various nodes 402 of the distributed trust computing network 400 have reached a consensus as to the ownership and validity/authenticity of authentication NFT 230, i.e., the linked data.

As shown in FIG. 10, a system 1000 for generating an NFT 230. Generating, otherwise referred to as “minting”, authentication NFT 230, is initiated by a user 1001 (e.g., NFT owner) who identifies, using a user input device 300, resources 1002 that the user wishes to mint as an NFT. Typically, the resources 1002 used to generate the NFTs are digital objects that represent both tangible and intangible objects. These resources 1002 may include a piece of art, music, collectible, virtual world items, videos, real-world items such as artwork and real estate, or any other presumed valuable object. According to embodiments of the present invention user credentials 1004 are either part of the resources or also used to generate the authentication NFT 230. These resources 1002 and user credentials 1004 are then digitized into a proper format to generate the NFT 230. Authentication NFT 230 may be a multi-layered documentation that identifies the resources 1002 and user credentials 1004 but also evidences various event conditions associated therewith.

To record authentication NFT 230 and/or authentication NFT metadata 270-1 in a distributed ledger 404, an event object 404-A for the authentication NFT 230 is created using data stored in database 1006. As previously discussed in relation to FIG. 9, the event object 404-A includes an event object header 406 and an event object data 408. The event object header 406 includes a cryptographic hash of the previous event object, a nonce (i.e., a random 32-bit whole number generated when the event object is created), a cryptographic hash of the current event object wedded to the nonce, and a time stamp. The event object data 408 includes the authentication NFT 230 and/or metadata 270-1 being recorded. Once the event object 404-A is generated, authentication NFT 230 is considered signed and persistently tied to its corresponding nonce and hash. The event object 404-A is then deployed in the distributed ledger 404. At this time, a distributed ledger address is generated for the event object 404-A, i.e., an indication of where authentication NFT 240 is located on the distributed ledger 404 and captured for recording purposes. Once deployed, authentication NFT 230 is linked permanently to the corresponding hash and the distributed ledger 404, and is considered recorded in the distributed ledger 404, thus concluding the generation/minting process.

As shown in FIG. 10 and previously discussed in relation to FIG. 8, the distributed ledger 404 may be maintained on multiple devices (nodes) 402 of the distributed trust computing network 400; the multiple nodes 402 are authorized to keep track of the distributed ledger 404. For example, the multiple nodes 404 may be computing devices such as a computing system or end-point device(s). Each node 402 may have a complete or partial copy of the entire distributed ledger 404 or set of events and/or event objects on the distributed ledger 404. Events, such as the recordation of authentication NFT 230, are initiated at a node 402 and communicated to the various nodes 402. Any of the nodes 402 can validate an event, record the event to the corresponding copy of the distributed ledger 404, and/or broadcast the event, its validation (in the form of an event object 404-A) and/or other data to other nodes 402.

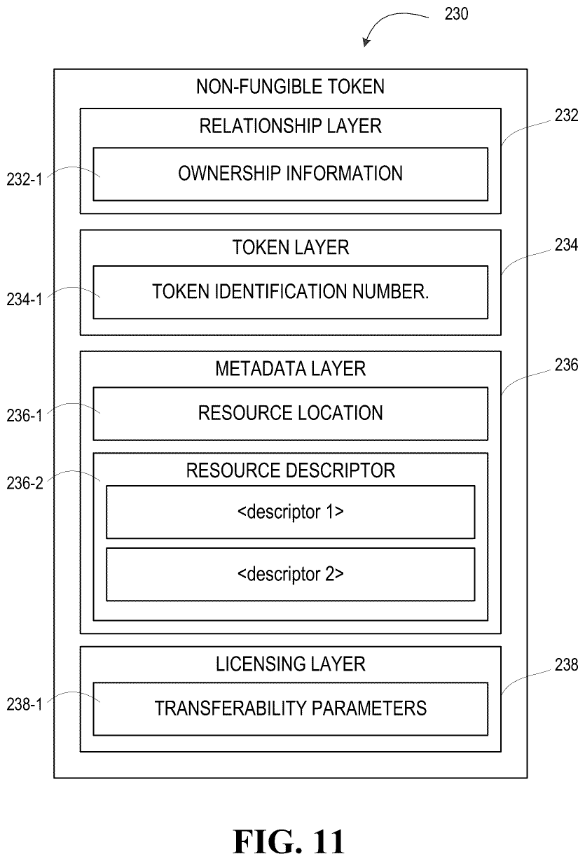

FIG. 11 illustrates an exemplary authentication NFT 230 as a multi-layered documentation of a resource 1002, in accordance with an embodiment of an invention. As shown in FIG. 11, the NFT 230 may include at least relationship layer 232, a token layer 234, a metadata layer 236, and, when applicable, a licensing layer 238. The relationship layer 232 may include ownership information 232-1, including a map of various users that are associated with the resource and/or the NFT 230, and their relationship to one another. For example, if the NFT 230 is acquired by user U1 from a user U2, the relationship between U1 and U2 is recorded in the relationship layer 232. In another example, if the NFT 230 is owned by O1 and the resource itself is stored in a storage facility by storage provider SP1, then the relationship between O1 and SP1 as owner-file storage provider is recorded in the relationship layer 232. The token layer 234 may include a token identification number 234-1 that is used to identify the NFT 230. The metadata layer 236 may include at least a resource location 236-1 and a resource descriptor 236-2. The resource location 236-1 provides information associated with the specific location of the resource 1002. Depending on the conditions listed in the smart contract underlying the distributed ledger 404, the resource 1002 may be stored on-chain, i.e., directly on the distributed ledger 404 along with the NFT 230, or off-chain, i.e., in an external storage location. The resource location 236-1 identifies where the resource 1002 is stored. The resource descriptor 236-2 includes specific information associated with the resource itself. For example, the resource descriptor 236-2 may include information about the supply, authenticity, lineage, provenance of the resource 1002. The licensing layer 238 may include any transferability parameters 238-1 associated with the NFT 230, such as restrictions and licensing rules associated with purchase, sale, and any other types of transfer of the resource 1002 and/or the NFT 230 from one person to another. Those skilled in the art will appreciate that various additional layers and combinations of layers can be configured as needed without departing from the scope and spirit of the invention.

Thus, present embodiments of the invention provide for generating an NFT digital wallet that stores an NFT that serves as verified identity for the user. The NFT digital wallet is generated with both a private side/portion of the wallet having a private address and public side/portion of the wallet having a public address are generated. Additionally, a set of rules are configured that provide gateway functionality for receiving resource-related events using the private address. The public address is used for transmitting outgoing resource-related events and receiving incoming resource-related events, while the private address is used to validate at least some of the incoming resource-related events. The incoming resource-related events requiring validation is defined by the set of rules. In use, launching of the NFT digital wallet and user authentication via NFT presentation prompts presentation of the private side and outstanding incoming resource-related events awaiting validation. Once incoming resource-related events are validated and the user is re-authenticated, the public side is presented along with validated incoming resource-related events. In addition, alternate embodiments of the invention provide for automatically updating/replacing the public address in response to an occurrence of a public exposure event or predicting the likely occurrence of a public exposure event. Such updating/replacement of the public address occurs without having to update/replace the private address.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein

What is claimed is:

1. A system for generating a Non-Fungible Token (NFT) digital wallet that provides gateway functionality for transmitting and receiving resource-related events, the system comprising:
a first computing platform including a first memory and one or more first processing devices in communication with the first memory, wherein the first memory stores an NFT digital wallet generator executable by at least one of the one or more first processing devices and configured to:
authenticate at least one of one or more users using an NFT that serves as verified identity for the one or more users,
in response to authenticating the at least one of the one or more users, generate a private side of a NFT digital wallet having a private address,
in response to generating the private side and based on authentication of the one or more users, receive a first input from a user from amongst the one or more users, the first input configured to generate a public side of the NFT digital wallet having a public address, and
receive second inputs from the user that define a set of rules for the NFT digital wallet to provide gateway functionality for receiving resource-related events using the public address and private address.

2. The system of claim 1, further for using the NFT digital wallet, wherein the NFT digital wallet is configured to:
transmit outgoing resource-related events via the public address,
receive incoming resource-related events via the public address, and
validate at least a portion of the received incoming resource events using the private address.

3. The system of claim 2, wherein the NFT digital wallet is further configured to:
apply the set of rules to each of the incoming resource-related events to determine which of the incoming resource-related events require validation using the private address and which of the incoming resource-related events can be accepted without requiring validation using the private address.

4. The system of claim 3, wherein the NFT digital wallet is further configured to:
in response to a user from amongst the one or more users launching the NFT digital wallet and initially authenticating the user using the NFT, present the private side of the NFT digital wallet and display information related to the incoming resource-related events requiring validation,
receive one or more third user inputs that select for validation one or more of the incoming resource-related events requiring validation, and
in response to receiving the one or more third user inputs, use the private address to validate the selected one or more incoming resource-related events requiring validation.

5. The system of claim 4, wherein the NFT digital wallet is further configured to:
in response to validating the selected one or more incoming resource-related events requiring validation, re-authenticate the user using the NFT, and
in response to re-authenticating the user, present the public side of the NFT digital wallet and display the validated one or more incoming resource-related events requiring validation as accepted incoming resource-related events.

6. The system of claim 1, further comprising a second computing platform including a second memory and one or more second processing devices in communication with the second memory, wherein the second memory stores a public address monitoring engine executable by at least one of the one or more second processing devices and configured to:
monitor for occurrence of public exposure of the public address, and
in response to the monitoring determining an occurrence of public exposure of the public address, direct the NFT to replace the public address with a new public address without having to replace the private address.

7. The system of claim 1, further comprising a second computing platform including a second memory and one or more second processing devices in communication with the second memory, wherein the second memory stores a public address exposure prediction engine executable by at least one of the one or more second processing devices and configured to:
monitor for occurrence of public events implementing the public address,
in response to the monitoring determining an occurrence of one or more public events implementing the public address, implement machine learning models to predict that the one or more public events will lead to an occurrence of public exposure of the public address, and
in response to predicting that the one or more public events will lead to the occurrence of public exposure of the public address, direct the NFT to automatically replace the public address with a new public address without having to replace the private address.

8. A computer-implemented method for generating a Non-Fungible Token (NFT) digital wallet that provides gateway functionality for transmitting and receiving resource-related events, the method executed by one or more computing processor device, the method comprises:
authenticating at least one of one or more users using an NFT that serves as verified identity for the one or more users;
in response to authenticating the at least one of the one or more users, generating a private side of a NFT digital wallet having a private address;
in response to generating the private side and based on authentication of the at least one of the one or more users, receiving a first input from a user from amongst the one or more users, the first input configured to generate a public side of the NFT digital wallet having a public address; and
receiving second inputs from the user that define a set of rules for the NFT digital wallet to provide gateway functionality for receiving resource-related events using the public address and private address.

9. The method of claim 8, further for using the NFT digital wallet and further comprising:
transmitting outgoing resource-related events via the public address;
receiving incoming resource-related events via the public address; and
validating at least a portion of the received incoming resource events using the private address.

10. The method of claim 9, further comprising:
applying the set of rules to each of the incoming resource-related events to determine which of the incoming resource-related events require validation using the private address and which of the incoming resource-related events can be accepted without requiring validation using the private address.

11. The method of claim 10, further comprising:
in response to a user from amongst the one or more users launching the NFT digital wallet and initially authenticating the user using the NFT, presenting the private side of the NFT digital wallet and displaying information related to the incoming resource-related events requiring validation;
receiving one or more third user inputs that select for validation one or more of the incoming resource-related events requiring validation; and
in response to receiving the one or more third user inputs, using the private address to validate the selected one or more incoming resource-related events requiring validation.

12. The method of claim 11, further comprising:
in response to validating the selected one or more incoming resource-related events requiring validation, re-authenticating the user using the NFT; and
in response to re-authenticating the user, presenting the public side of the NFT digital wallet and displaying the validated one or more incoming resource-related events requiring validation as accepted incoming resource-related events.

13. The method of claim 8, further comprising:
monitoring for occurrence of public exposure of the public address; and
in response to the monitoring determining an occurrence of public exposure of the public address, directing the NFT to automatically replace the public address with a new public address without having to replace the private address.

14. The method of claim 8, further comprising:
monitoring for occurrence of public events implementing the public address;
in response to the monitoring determining an occurrence of one or more public events implementing the public address, implementing machine learning models to predict that the one or more public events will lead to an occurrence of public exposure of the public address; and
in response to predicting that the one or more public events will lead to the occurrence of public exposure of the public address, directing the NFT to automatically replace the public address with a new public address without having to replace the private address.

15. A computer program product comprising:
a non-transitory computer-readable medium comprising sets of codes for causing one or more computing processing devices to:
authenticate at least one of one or more users using an NFT that serves as verified identity for the one or more users;
in response to authenticating the at least one of the one or more users, generate a private side of a NFT digital wallet having a private address;
in response to generating the private side and based on authentication of the at least one of the one or more users, receive a first input from a user from amongst the one or more users, the first input configured to generate a public side of the NFT digital wallet having a public address; and
receive second inputs from the user that define a set of rules for the NFT digital wallet to provide gateway functionality for receiving resource-related events using the public address and private address.

16. The computer program product of claim 15, wherein the sets of codes further cause the one or more computing processing devices to:
transmit outgoing resource-related events via the public address;
receive incoming resource-related events via the public address; and
validate at least a portion of the received incoming resource events using the private address.

17. The computer program product of claim 16, wherein the sets of codes further cause the one or more computing processing devices to:
apply the set of rules to each of the incoming resource-related events to determine which of the incoming resource-related events require validation using the private address and which of the incoming resource-related events can be accepted without requiring validation using the private address.

18. The computer program product of claim 17, wherein the sets of codes further cause the one or more computing processing devices to:
in response to a user from amongst the one or more users launching the NFT digital wallet and initially authenticating the user using the NFT, present the private side of the NFT digital wallet and displaying information related to the incoming resource-related events requiring validation;
receive one or more third user inputs that select for validation one or more of the incoming resource-related events requiring validation; and
in response to receiving the one or more third user inputs, use the private address to validate the selected one or more incoming resource-related events requiring validation.

19. The computer program product of claim 15, wherein the sets of codes further cause the one or more computing processing devices to:
monitor for occurrence of public exposure of the public address; and
in response to the monitoring determining an occurrence of public exposure of the public address, direct the NFT to automatically replace the public address with a new public address without having to replace the private address.

20. The computer program product of claim 15, wherein the sets of codes further cause the one or more computing processing devices to:
monitor for occurrence of public events implementing the public address;
in response to the monitoring determining an occurrence of one or more public events implementing the public address, implement machine learning models to predict that the one or more public events will lead to an occurrence of public exposure of the public address; and
in response to predicting that the one or more public events will lead to the occurrence of public exposure of the public address, direct the NFT to automatically replace the public address with a new public address without having to replace the private address.
